(19) United States
(12) Patent Application Publication
(10) Pub. No.: US 2009/0323856 A1
(43) Pub. Date: Dec. 31, 2009

(54) TRANSMIT-CANCELING TRANSCEIVER RESPONSIVE TO HEAT SIGNAL AND METHOD THEREFOR

(75) Inventor: Ronald Duane McCallister, Scottsdale, AZ (US)

Correspondence Address: MESCHKOW & GRESHAM, P.L.C., 5727 NORTH SEVENTH STREET, SUITE 409, PHOENIX, AZ, 85014, US

(73) Assignee: CrestCom, Inc., Scottsdale, AZ (US)

(21) Appl. No.: 12/163,013

(22) Filed: Jun. 27, 2008

(51) Int. Cl. H04L 25/49

(52) U.S. Cl. 375/296

(57) ABSTRACT

A transmit-canceling transceiver (10) generates a heat signal (84) that estimates heating in analog components which process a transmit signal (22). An equalizer (74) having taps (77) provided by a tap update section (78) processes the transmit signal (22) for use in a cancellation operation. The tap update section (78) includes a coefficient update section (82) and a heat adjustment section (80). The coefficient update section (82) implements a feedback loop to generate coefficients (86) which are substantially unresponsive to the heat signal (84). The heat adjustment section (80) closes a feedback loop which is responsive to the heat signal (84) and generates offsets (142) that are used to adjust the coefficients (86) to compensate for heating. The loop bandwidth of the feedback loop of coefficient update section (82) is sufficiently narrow so as to be unable to track dynamic heat effects from the analog components.

### TECHNICAL FIELD OF THE INVENTION

The present invention relates generally to the field of radios that include both a transmitter and a receiver. More specifically, the present invention relates to such radios in which cancellation techniques reduce the corruption of a receive signal caused by a transmit signal. And, the present invention relates to such radios in which compensation is provided for signal-generated component heating.

### BACKGROUND OF THE INVENTION

Radios that include both a transceiver and a receiver (i.e., transceivers) often have an ability to transmit and receive simultaneously. This ability requires that transmission and reception occur in different frequency bands. Such a transceiver should be configured so that its transmitter's outgoing transmit signal does not interfere with the incoming receive signal intended for its receiver. Such interference becomes less of a problem when the transmit frequency band is spaced farther apart from the receive frequency band in the electromagnetic spectrum, when the radio's transmit power is lower or the remote device's transmit power is higher, and/or when a higher quality duplexer is used. But in some radio applications, the available portions of electromagnetic spectrum simply do not permit as much spacing between transmit and receive bands as might be desired. And, in some radio applications, higher local transmit power is required to achieve link margins over the desired radio coverage area, or remote devices simply cannot transmit at higher power due to regulations and/or a need to preserve battery reserves. And, high quality duplexers may simply be impractical in some radio applications because high quality duplexers tend to be very expensive and/or very large.

In situations were transmit and receive bands are near each other, where transmit power is high or the remote device's transmit power is low, and/or where lower quality duplexers are called for, cancellation techniques have been applied to further reduce corruption of the receive signal caused by the transmit signal. Generally, cancellation techniques call for extracting a small portion of the transmit signal, processing this extracted portion, and then subtracting it from the receive signal. The processing alters the extracted transmit signal's timing, amplitude, and phase to match the transmit-signal interference that has corrupted the receive signal. Often, the processing takes place using an adaptive equalizer whose filter characteristics are continuously adjusted to improve the match.

But conventional canceling techniques have failed to adequately reduce corruption of a receive signal by a transmit signal. As a result, in order to use conventional cancellation techniques and sufficiently reduce corruption of a receive signal by a transmit signal, undesirably expensive or large duplexers are still required, transmit and receive bands are separated from one another by spectral distances that result in painful wastes of spectrum, and remote devices are forced to transmit at undesirably high power levels to overcome the remaining interference.

It is believed the poor performance demonstrated by conventional cancellation techniques is due, at least in part, to the large temporal scale over which precision in processing the transmit signal should be maintained. Better cancellation requires a better match between a reference transmit signal and the interfering portion of the receive signal. In order to get a more precise match, a feedback loop that drives the adaptive equalizer processing the transmit signal should have a narrower loop bandwidth. In other words, the feedback loop should interpret almost all mismatches as noise, and ignore them unless they persist in a consistent way for a very long duration.

On the other hand, the amplitude and/or phase characteristics of the corrupted receive signal and reference transmit signal change as a result of temperature and humidity changes, component aging, and the like. In order to maintain a precise match, corresponding characteristics of the processed transmit signal should track such changes. Many of these agents of change occur slowly and may be tracked even by a narrow loop bandwidth in the feedback loop that drives the adaptive equalizer processing the transmit signal.

But a portion of the temperature changes may be due to signal-generated component heating. In other words, an analog component's temperature rises and falls in response to the power level of the signal it processes. This type of temperature change can rapidly produce a mismatching effect. In order to better track such temperature changes, the feedback loop that drives the adaptive equalizer processing the transmit signal should have a wider loop bandwidth. Thus, conventional canceling techniques strike a compromise between these two competing design considerations that simultaneously call for both a narrower and a wider loop bandwidth. As a result of the compromise, the reference transmit signal is not processed adequately to achieve both a precise match and to track changes.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a block diagram of a transmit-canceling transceiver configured in accordance with one embodiment of the present invention;

FIG. 2 shows a block diagram of one embodiment of a receiver portion of the transmit-canceling transceiver depicted in FIG. 1;

FIG. 3 shows a block diagram of one embodiment of a coefficient update section of the receiver depicted in FIG. 2;

FIG. 4 shows a block diagram of one embodiment of a heat adjustment section of the receiver depicted in FIG. 2; and

FIG. 5 shows an alternate embodiment of an equalizer portion of the receiver depicted in FIG. 2.

### DETAILED DESCRIPTION OF THE PREFERRED EMBODIMENTS

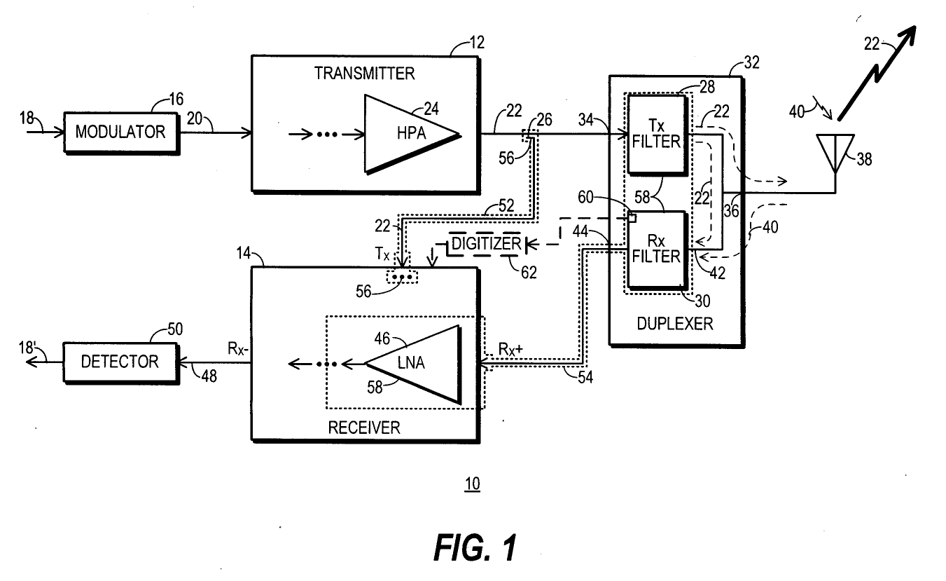

FIG. 1 shows a block diagram of a transmit-canceling transceiver 10 configured in accordance with one embodiment of the present invention. Transceiver 10 includes an RF transmitter 12 and an RF receiver 14. Transceiver 10 is the type of transceiver that may be used at a cellular telephony cell-site base station, but transceiver 10 may be used in other applications as well, including mobile subscriber equipment (e.g., cell phones, laptops, etc.).

A modulator 16 receives raw data 18 and digitally modulates raw data 18 into a modulated data stream 20 that is provided to an input of RF transmitter 12. In a preferred embodiment, modulator 16 is configured so that modulated data stream 20 conveys raw data 18 in a coded form and is arranged as a complex data stream having quadrature phase components. Complex notation is omitted from the figures in order to simplify the presentation of this material. The type of modulation used by modulator 16 to produce modulated data stream 20 is not a critical parameter of the present invention. Examples of modulations that may be implemented in modulator 16 include any type of quadrature amplitude modulation (QAM), code-division-multiple-access (CDMA), orthogonal frequency division modulation (OFDM), multiple-input, multiple-output (MIMO), and the like. Modulated data stream 20 may be viewed as a wideband data stream and may have resulted from combining a plurality of independently modulated, complex data streams together into a single modulated data stream 20. The plurality of data streams may correspond to different channels, and the different channels may be configured for a frequency division duplex (FDD) or a multichannel time division duplex (TDD) communication system. In addition, other processing may have been applied to modulated data stream 20 in modulator 16. Such other processing may include pulse shaping filters that are configured to minimize inter-symbol interference (ISI) and peak or crest reduction circuits that reduce the peak-to-average power ratio of modulated data stream 20.

RF transmitter 12 generates an RF transmit signal 22 from modulated data stream 20. In a preferred embodiment, RF transmitter 12 includes predistortion circuits, digital-to-analog conversion circuits, upconversion circuits, and a bandpass filter, each of which is omitted from FIG. 1 but may be implemented and operated in a conventional manner. In addition, transmitter 12 includes a high power amplifier (HPA) 24 which supplies RF transmit signal 22. Moreover, in accordance with the wide variety of the modulation formats which may be followed by modulator 16, the power of transmit signal 22 will vary under normal operating conditions for transceiver 10, and is likely to vary considerably. For the purposes of this description, RF transmit signal 22 and all variants thereof produced by downstream processing in transceiver 10 are referred to as transmit signal 22 (T_{X}) to distinguish them from an RF receive signal and a transmit-corrupted receive signal discussed below. Thus, transmit signal 22 is processed through high-power amplifier 24 and, for the embodiment depicted in FIG. 1, routed through a directional coupler 26 to a transmit filter 28.

In the embodiment depicted in FIG. 1, transmit filter 28 and a receive filter 30 are provided by a multiport device in the form of a duplexer 32. The use of duplexer 32 is advantageous in a communication system where one or more channels are dedicated to transmission, one or more channels are dedicated to reception, and no channels are used to both transmit and receive. Desirably, the transmit channels are spaced apart from the receive channels in the electromagnetic spectrum by as great a spectral distance as is practical. But the benefits of the present invention are best appreciated in situations where it is impractical to space the transmit channels sufficiently far from the receive channels so that transmit signal interference in the receive signal is easily avoided. In such situations, filtering provided by a duplexer may be used to help isolate receiver 14 from transmitter 12. But a duplexer is only one form of multiport device that may be used by transceiver 10. Alternate embodiments of transceiver 10 may use a circulator, a duplexer in combination with a circulator and external filtering, a circulator in combination with external filtering, separate antennas for transmit and receive signals, or other form of multiport device instead of the single duplexer depicted in FIG. 1.

An input of transmit filter 28 serves as a transmitter port 34 for duplexer 32 and couples to an output of transmitter 12 through directional coupler 26. Within duplexer 32, an output of transmit filter 28 couples to an input of receive filter 30 and serves as an antenna port 36 for duplexer 32. Thus, transmit signal 22 passes through directional coupler 26 and duplexer 32 at transmit filter 28, to an antenna 38, where it is broadcast from transceiver 10 with the intention of being received by some remotely located transceiver or receiver. To the maximum extent practical, transmit filter 28 passes signal energy in the frequency band where the transmit channels are located and attenuates signal energy outside this transmit band. In one an alternate embodiment, directional coupler 26 may be located between duplexer 32 and antenna 38, rather than as shown in FIG. 1. In another alternate embodiment, rather than directional coupler 26, duplexer 32 may be used to extract a small portion of transmit signal 22 for use in a cancellation operation performed in receiver 14, and a circulator (not shown) located between duplexer 32 and antenna 38 to separate an RF receive signal 40 from the transmit signal 22. In this embodiment, a separate receive bandpass filter (not shown) may be located between the circulator and receiver 14 to perform the function of receive filter 30 in the embodiment depicted in FIG. 1.

RF receive signal 40 is received at antenna 38. In the preferred embodiments, receive signal 40 may be received at antenna 38 simultaneously with the broadcasting of transmit signal 22 from antenna 38. The signal level of receive signal 40 is likely to be far, far lower than that of transmit signal 22. Receive signal 40 passes to antenna port 36 of duplexer 32 and an input of receive filter 30.

Due to the multiport operation of duplexer 32, the signal level of transmit signal 22 propagating toward receive filter 30 may be considerably reduced from the signal level of transmit signal 22 propagating toward antenna 38. And, due to the spacing of the transmit band apart from a receive band, and to the filtering operation of transmit filter 28, the portion of the signal energy from transmit signal 22 that resides in the receive band with receive signal 40 may be far reduced from the transmit band energy propagating toward antenna 38. But, due to the far, far greater signal level of transmit signal 22 compared to receive signal 40, transmit signal 22 may still potentially interfere with receive signal 40, and the potential for interference is greater the spectrally closer the transmit band is to the receive band.

Receive filter 30 thus receives a composite of transmit signal 22 and receive signal 40. This composite signal is referred to herein as a transmit-corrupted receive signal (R_{X}+) 42. For the purposes of this description, transmit-corrupted receive signal 42 and all variants thereof produced in transceiver 10 subsequent to the reception of receive signal 40 at antenna 38 are referred to as transmit-corrupted receive signal 42 to distinguish them from transmit signal 22.

An output of receive filter 30 couples to a signal input of RF receiver 14 and serves as a receiver port 44 for duplexer 32. To the maximum extent practical, receive filter 30 blocks RF transmit signal 22 but passes RF receive signal 40. In particular, to the maximum extent practical, receive filter 30 passes signal energy in the frequency band where the receive channels are located and attenuates signal energy outside the receive band, and particularly in the transmit band. But to some extent, transmit signal 22 leaks into transmit-corrupted receive signal 42 at the output of receive filter 30.

Desirably, the amount of leakage is as low as practical. In addition to spectrally spacing transmit and receive bands as far apart as possible, leakage may be further reduced through the use of a high quality duplexer. But the benefits of the present invention are best appreciated in situations where it may be impractical to use a high quality duplexer, whether due to the high cost traditionally associated with high quality duplexers or to space limitations. Accordingly, at the output of receive filter 30, transmit-corrupted receive signal 42 may be expected to include a troublesome amount of transmit signal 22 combined with receive signal 40.

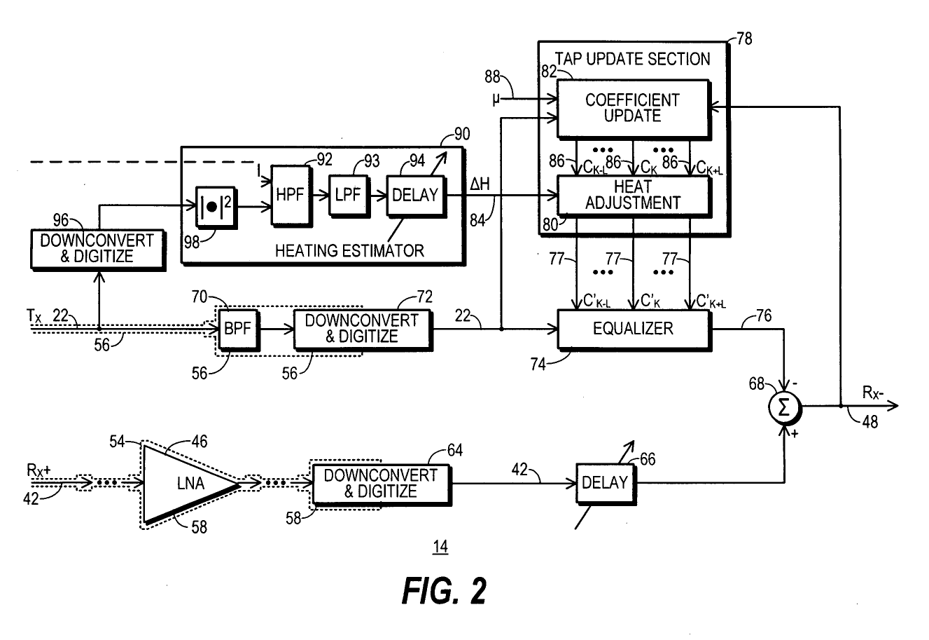

A portion, and preferably a very small portion, of transmit signal 22 is extracted at a coupled port of directional coupler 26 and routed to a control input of receiver 14. Receiver 14 includes a low noise amplifier (LNA) 46 along with other conventional circuits (not shown) which serve to downconvert and digitize transmit-corrupted receive signal 42. In addition, receiver 14 includes circuits to process transmit signal 22 and then combine the processed transmit signal with transmit-corrupted receive signal 42 to form a transmit-cancelled receive signal (R_{X}−) 48. Desirably, the combining operation reduces transmit signal 22 corruption in receive signal 40 by canceling a significant amount of transmit signal 22 that was included with receive signal 40 in transmit-corrupted receive signal 42. The processing and combining operations for a preferred embodiment of the present invention are discussed below in connection with FIGS. 2-5.

Transmit-cancelled receive signal 48 then passes to a detector 50. Detector 50 receives and demodulates transmit-cancelled receive signal 48 to produce raw data 18′. Desirably, the interference caused by transmit signal 22 with receive signal 40 has been ameliorated through the cancellation operation carried out in receiver 14 so that detector 50 provides raw data 18′ that is substantially equivalent to raw data 18. Detector 50 desirably performs a complementary operation to modulator 16.

FIG. 1 shows that transmit signal 22 follows a transmit signal path 52 toward and into receiver 14 and that transmit signal 22 also follows a separate receive signal path 54 toward and into receiver 14. RF transmit signal 22 may also follow other paths into receiver 14, including radiated leakage, power supply lines, and the like. In the below discussion, receive signal path 54 will represent a combination of all such paths. As discussed above, in receive signal path 54, transmit signal 22 becomes an interfering portion of transmit-corrupted receive signal 42. Transmit signal path 52 includes a first set 56 of analog components, including directional coupler 26 and other components within receiver 14. Receive signal path 54 includes a second set 58 of analog components, including transmit and receive filters 28 and 30, low noise amplifier 46, and other components within receiver 14. First and second sets 56 and 58 of analog components may have some analog components in common, but will have some analog components that are unique to each set. For example, FIG. 1 shows that receive filter 30 is included only in second set 58 of analog components.

Unlike signals processed by digital components, signals processed by analog components, whether active or passive, are influenced by temperature changes normally experienced within the components' operational temperature ranges. Such influences may include phase changes, gain changes, group delay changes, bandwidth alterations, DC offset changes, and the like. For higher quality analog components the influence of temperature tends to be less than for lower quality analog components. But temperature influences nevertheless occur. And, the use of higher quality analog components is simply impractical for many transceiver applications due to the higher costs typically associated with higher quality components. Accordingly, transmit signal 22 and transmit-corrupted receive signal 42 are likely to be influenced by temperature changes.

Transmit signal 22 thus propagates toward and into receiver 14 through at least two separate signal paths 52 and 54. Through much of receive signal path 54, transmit signal 22 propagates as one component of transmit-corrupted receive signal 42. Under steady state temperature conditions, processing which takes place in receiver 14 desirably causes transmit signal 22 to precisely match the interfering portion of transmit-corrupted receive signal 42 in amplitude, phase, delay, and over the entire relevant bandwidth. But steady state temperature conditions are not normal operating conditions. When an analog component unique to either first or second set 56 or 58 of analog components experiences a temperature change, particularly a temperature change not experienced by the other set of analog components, the precision with which transmit signal 22 matches the interfering portion of transmit-corrupted receive signal 42 deteriorates. As a result, unless receiver 14 is able to track the effects of such temperature changes, the ability of receiver 14 to cancel interference caused by transmit signal 22 likewise deteriorates.

Receive filter 30, located in receive signal path 54, provides one example of an analog component which is likely to experience temperature changes not experienced by analog components in transmit signal path 52. Receive filter 30 may be configured to block a significant portion of the energy from transmit signal 22. As the power level of transmit signal 22 changes, signal-generated component heating results. In other words, an increased power level of transmit signal 22 results in increased power dissipation in receive filter 30 and an increase in temperature for receive filter 30. Then, when the power level of transmit signal 22 decreases, the temperature likewise decreases. When temperature changes at receive filter 30, center and corner frequencies change, causing phase and amplitude shifts. But receive filter 30 is only one example of an analog component which suffers from temperature influences. The temperature influences experienced by each component in each of signal paths 52 and 54 are experienced independently and in different amounts for each component. Consequently, the overall temperature influence results from the cumulative temperature influences of each component, and is in a constant state of flux as power levels and the ambient temperature change.

The ambient temperature may be assumed to change at a sufficiently slow rate so that a feedback loop which processes transmit signal 22 to achieve a precise match with the interfering portion of transmit-corrupted receive signal 42 can track ambient temperature changes. But signal-generated component heating occurs much more quickly. A feedback loop which processes transmit signal 22 may not be able to both achieve a sufficiently precise match with the interfering portion of transmit-corrupted receive signal 42 and track the effects of signal-generated component heating. The embodiment of receiver 14 discussed below in connection with FIGS. 2-5 is configured to achieve both precision in matching transmit signal 22 with the interfering portion of transmit-corrupted receive signal 42 and tracking for signal-generated component heating.

FIG. 1 uses dotted lines to show an embodiment of the present invention wherein a temperature measuring device 60, such as a thermocouple or the like, is physically attached to at least one analog component in at least one of signal paths 52 and 54 for the purpose of measuring that component's temperature. FIG. 1 shows that temperature measuring device 60 is located on duplexer 32, perhaps near receive filter 30, but temperature measuring device 60 could also be located on other analog components. Desirably, a component is selected which drastically experiences signal-generated component heating. Temperature measuring device 60 couples to a digitizer 62 to convert the resulting heat signal into a digital form, and the digital form of the heat signal is routed to a control input of receiver 14.

FIG. 2 shows a block diagram of one embodiment of receiver 14. Transmit-corrupted receive signal 42 is directed through an arrangement of analog components, depicted in FIG. 2 by an ellipsis, to an input of low noise amplifier (LNA) 46. An output of amplifier 46 provides transmit-corrupted receive signal 42, now amplified, through an arrangement of analog components, depicted in FIG. 2 by an ellipsis, to an input of a downconversion and digitizing section 64. Amplifier 46, downconvert and digitize section 64, and the arrangements of analog components surrounding amplifier 46 are included in receive signal path 54 as a part of second set 58 of analog components.

Downconvert and digitize section 64 downconverts transmit-corrupted receive signal 42 to baseband and digitizes the signal. Section 64 may, but is not required to, process transmit-corrupted receive signal 42 through an intermediate frequency in forming the baseband signal. But it is desirable that the downconversion be coherent with the upconversion performed in transmitter 12 (FIG. 1) so that the interfering portion of transmit-corrupted receive signal 42 ends up being substantially phase coherent with a baseband form of transmit signal 22 (discussed below) that receiver 14 also forms. Section 64 may use any of a variety of conventional digitization techniques to convert transmit-corrupted receive signal 42 into a digital form, but higher resolution techniques are more preferred. A digital, baseband version of transmit-corrupted receive signal 42 is provided at an output of downconvert and digitize section 64 and routed to an input of a variable delay section 66. An output of variable delay section 66 couples to a positive input of a digital combiner 68. After being processed through received signal path 54, downconverted, and digitized, transmit-corrupted receive signal 42 is then provided to the positive input of digital combiner 68, wherein an output of combiner 68 generates transmit-cancelled receive signal 48.

Transmit signal 22 is directed along transmit signal path 52 to a bandpass filter 70. Preferably, bandpass filter 70 exhibits a transfer function approximately equal to the transfer function of receive filter 30 within duplexer 32. In other words, bandpass filter 70 passes the receive frequency band and attenuates the transmit frequency band. Transmit-corrupted receive signal 42 passes through receive filter 30 prior to arriving at combiner 68. With bandpass filter 70 having an approximately equal transfer function, transmit signal 22 after filtering in bandpass filter 70 should include components spectrally close to the interfering portion of transmit-corrupted receive signal 42. But bandpass filter 70 need not exhibit an exactly equal transfer function to that of receive filter 30. For example, bandpass filter 70 may be formed from less expensive filter components than receive filter 30. Any inequality in transfer function will be compensated for in an equalizer (discussed below) which is adaptively adjusted in a feedback loop to maximize the achievable cancellation.

An output of bandpass filter 70 couples to an input of a downconversion and digitizing section 72. Downconvert and digitize section 72 downconverts transmit signal 22 to baseband and digitizes the signal. Section 72 may, but is not required to, process transmit signal 22 through an intermediate frequency in forming the baseband signal. But it is desirable that the downconversion be coherent with the upconversion performed in transmitter 12 (FIG. 1) and with the downconversion performed in downconvert and digitize section 64 so that the interfering portion of transmit-corrupted receive signal 42 ends up being substantially phase coherent with this baseband form of transmit signal 22. Section 72 may use any of a variety of conventional digitization techniques to convert transmit signal 22 into a digital form, but a presently preferred version uses a digital subharmonic sampling downconversion to both downconvert and digitize transmit signal 22 and exhibits a resolution compatible with the digitization resolution from downconvert and digitize section 64. A digital, baseband version of transmit signal 22 is provided at an output of downconvert and digitize section 72 and routed to a signal input of an equalizer 74. After being processed through transmit signal path 52, downconverted, and digitized, then equalized in equalizer 74, transmit signal 22 is provided to a negative input of combiner 68. The equalized version of transmit signal 22 output by equalizer 74 is referred to as equalized transmit signal 76 below.

Equalizer 74 is desirably a digital filter. The precise type of filter may vary from application to application, but finite impulse response (FIR) or transversal forms of filters will be adequate for many applications. The filtering characteristics implemented by equalizer 74 are determined by a set of taps 77 provided to equalizer 74 by a tap update section 78.

Equalizer 74 will impose delay on equalized transmit signal 76. Consequently, variable delay section 66 is adjusted to achieve temporal alignment between equalized transmit signal 76 and the interfering portion of transmit-corrupted receive signal 22 at combiner 68. In other words, variable delay element 66 is adjusted so that transmit signal 22 arrives at the positive input of combiner 68 after propagating through receive signal path 54 as a part of transmit-corrupted receive signal 42 at the same instant it arrives at the negative input of combiner 68 after propagating through transmit signal path 52. Desirably, variable delay section 66 has the ability to delay samples by both an integral number of clock cycles and a fractional portion of a clock cycle to achieve high precision in temporally aligning equalized transmit signal 76 with transmit-corrupted receive signal 42.

Tap update section 78 is configured to adaptively generate taps 77 provided to equalizer 74. Taps 77 define the filter characteristics implemented by equalizer 74. Tap update section 78 includes a heat adjustment section 80 and a coefficient update section 82. Heat adjustment section 80 receives and is responsive to a heat signal (ΔH) 84. Heat signal 84 is generated in response to temperatures experience by components which process transmit signal 22 or an estimate of those temperatures.

Coefficient update section 82 generates coefficients 86 that are substantially unresponsive to heat signal 84. In one embodiment, the coefficient update section 82 implements a least-means square (LMS) coefficient adaptation algorithm. Thus, the output of combiner 68 couples to a first input of coefficient update section 82 to provide transmit-cancelled receive signal 48. And, the digitized, baseband form of transmit signal 22 from downconvert and digitize section 72 is routed to a second input of coefficient update section 82 to provide transmit-cancelled receive signal 48. Furthermore, a loop bandwidth constant 88, which is given the label “μ” in FIG. 2, is provided to coefficient update section 82 to control a loop bandwidth parameter of a feedback loop that coefficient update section 82 closes to generate coefficients 86 for equalizer 74.

But at least some of the coefficients 86 generated by coefficient update section 82 are not provided directly to equalizer 74. Rather, heat adjustment section 80 forms the taps 77 provided to equalizer 74 by adjusting the coefficients 86 generated in coefficient update section 82 to account for signal-generated component heating.

In one embodiment, a heating estimator 90 generates heat signal 84 in response to temperature measurements taken at one of the analog components from either of the first or second sets 56 or 58 of analog components discussed above. A dotted line in FIG. 2 indicates that the digital heat signal from digitizer 62 (FIG. 1) may be applied to a high pass filter (HPF) 92. In this embodiment, a second input to high pass filter 92 shown in FIG. 2 as a solid line may be omitted. An output from high pass filter 92 signals changes from a nominal ambient or long-term average temperature. This output is filtered in a low pass filter 93, then delayed in a variable delay element 94 and presented as heat signal 84. Low pass filter 93 is desirably configured so that its corner frequency roughly matches the thermal time constant of the components that exhibit heating influences.

But in another, and presently more preferred, embodiment, heating estimator 90 generates heat signal 84 in response to some form of transmit signal 22. In the embodiment shown in FIG. 2, a portion of the RF form of transmit signal 22 is desirably diverted to a downconversion and digitizing section 96 along a signal path configured to pass the transmit band. In other words, transmit signal 22 is routed to section 96 upstream of band pass filter 70, which is configured to block the transmit band. Section 96 downconverts transmit signal 22 to baseband and digitizes the signal. Then, the digitized, baseband form of transmit signal 22 is routed to heating estimator 90 at an input of a magnitude circuit 98, which determines the square of the magnitude of the digitized, baseband form of transmit signal 22.

In another embodiment (not shown), a version of modulated data stream 20, or a processed version of modulated data stream 20, may be routed to magnitude circuit 98, and section 96 may be omitted. In yet another embodiment (not shown), the form of transmit signal 22 which drives section 96 may be extracted between duplexer 32 and antenna 38 (FIG. 1). The digitized, baseband form of this transmit signal 22 may then be used for other purposes in addition to driving heating estimator 90, including the provision of feedback for predistortion implemented in transmitter 12.

An output from magnitude circuit 98 is routed to high pass filter 92. In this embodiment, temperature measurement device 60 (FIG. 1), digitizer 62 (FIG. 1) and the dotted line input to high pass filter 92 may be omitted. Temperature changes experienced by the first and second sets 56 and 58 of analog components are assumed to be related to the cumulative power transmit signal 22 has exhibited in the recent past. Fluctuations from a nominal ambient or long-term average power are passed by high pass filter 92 and presented as heat signal 84 after filtering in low pass filter 93 and delay in delay element 94. Delay element 94 is configured to temporally align heat signal 84 with coefficients 86 inside heat adjustment section 80. Regardless of which of the several embodiments that may be used to generate heat signal 84, heat signal 84 is responsive to temperatures experienced by at least one component from first and second sets 56 and 58 of analog components. Moreover, heat signal 84 desirably characterizes changes from a nominal ambient or longer term average rather than an absolute temperature or power level.

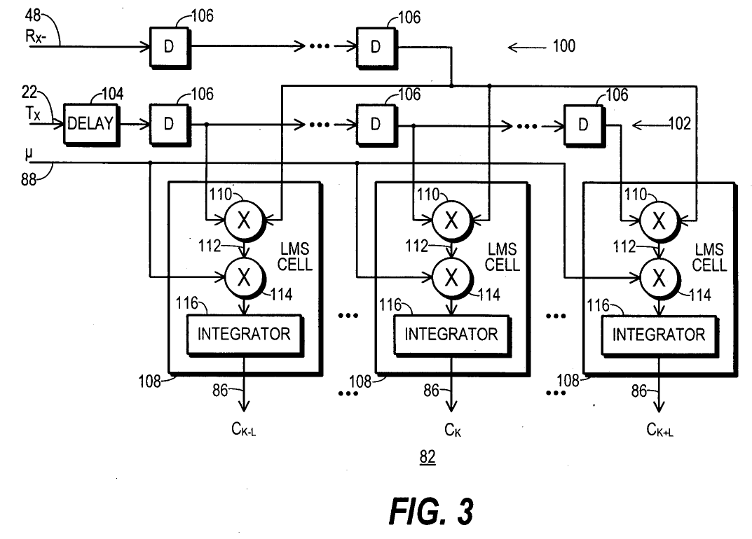

FIG. 3 shows a block diagram of one embodiment of coefficient update section 82. In this embodiment, coefficient update section 82 implements a form of an LMS adaptation algorithm. In particular, coefficient update section 82 receives transmit-cancelled receive signal 48 at a first delay line 100 and receives the digital, baseband form of transmit signal 22 at a second delay line 102. Second delay line 102 includes a delay element 104 that delays transmit signal 22 into temporal alignment with transmit-cancelled receive signal 48. The delay imposed by delay element 104 compensates for the delay imposed by equalizer 74 and combiner 68. Second delay line 102 also includes any number of one-sample delay stages 106. First delay line 100 desirably includes about one-half the number of one-sample delay stages 106 as are included in second delay line 102. Thus, transmit-cancelled receive signal 48 is delayed to the middle of second delay line 102 in this embodiment.

An LMS cell 108 is provided for each one-sample delay stage in second delay line 102. Each LMS cell 108 is configured substantially the same as the others. Each LMS cell 108 includes a multiplier 110 at which the feedback loop is closed. Multiplier 110 receives a delayed form of transmit signal 22 from second delay line 102, with the amount of delay corresponding to the position of the LMS cell 108 relative to second delay line 102. Multiplier 110 in each LMS cell 108 also receives the form of transmit-cancelled receive signal 48 that has been delayed to about the middle of second delay line 102. Multiplier 110 generates a correlation stream 112 that signals an amount of correlation between transmit signal 22 and transmit-cancelled receive signal 48, at varying stages of relative delay.

In each LMS cell 108, the corresponding correlation stream 112 is routed to a first input of a multiplier 114, and a second input of the multiplier 114 receives loop bandwidth constant 88. The smaller of a value provided for loop bandwidth constant 88, the narrower the loop bandwidth. An output of multiplier 114 in each LMS cell 108 couples to an input of an integrator 116, and an output of each integrator 116 provides a coefficient 86.

In the preferred embodiment, a sufficiently small value for loop bandwidth constant 88 is provided so that the loop bandwidth of each LMS cell 108 is too narrow to track the influences of signal-generated heating in components which process transmit signal 22, even should heat adjustment section 80 be disabled and make no adjustments to coefficients 86. But such a narrow loop bandwidth is desirable because it allows the feedback loop closed in coefficient section 82 to identify very small amounts of correlation between transmit signal 22 and transmit-cancelled receive signal 48. Consequently, coefficient update section 82 is able to form coefficients 86 that allow equalizer 74 (FIG. 2) to achieve a highly precise match between equalized transmit signal 76 and transmit-corrupted receive signal 42. Those skilled in the art will appreciate that the feedback loop of coefficient update section 82 may nevertheless be marginally responsive to signal-generated component heating. As is discussed below, heat adaptation section 80 operates to minimize the marginal response in this feedback loop to signal-generated component heating.

But, due at least in part to this narrow loop bandwidth, coefficients 86 are largely unresponsive to the effects of signal-generated component heating and to heat signal 84 (FIG. 2). It is heat adjustment section 80 (FIG. 2) that responds to signal-generated component heating and to heat signal 84 so that the effects of signal-generated component heating are addressed and so that taps 77 (FIG. 2) cause equalizer 74 (FIG. 2) to achieve a highly precise match between equalized transmit signal 76 and transmit-corrupted receive signal 42 even in the presence of signal-generated component heating.

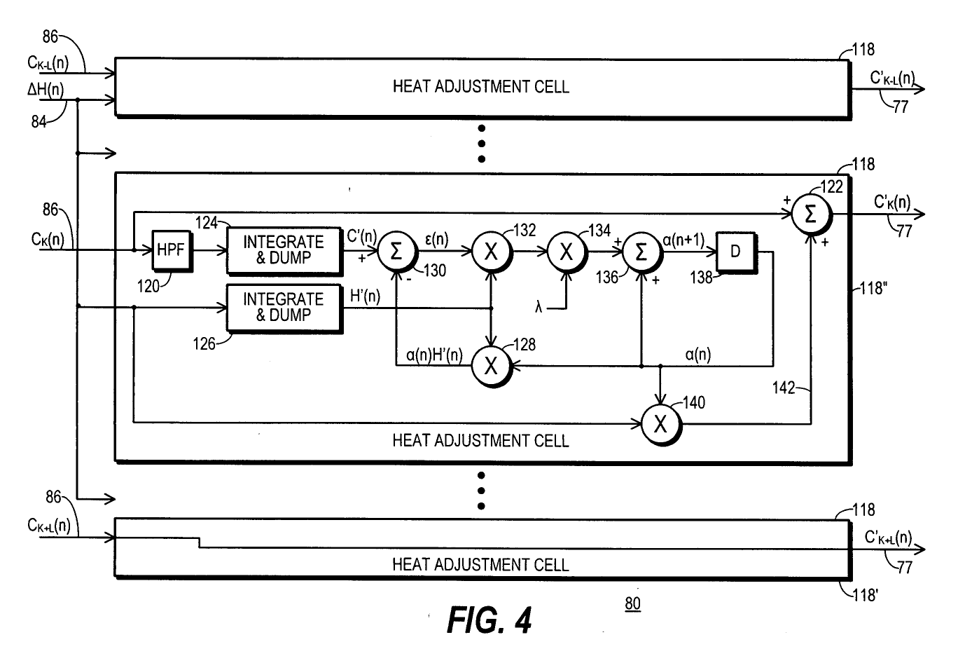

FIG. 4 shows a block diagram of one embodiment of heat adjustment section 80. In the embodiment depicted in FIG. 4 any number of heat adjustment cells 118 may be employed, with one cell 118 being provided for each coefficient 86. FIG. 4 also shows that two different types of heat adjustment cells 118 may be used. In a first type of heat adjustment cell 118′, the corresponding coefficient 86 may be passed through the first cell 118′ without further processing, except possibly for delay (not shown), and directly used as a tap 77 provided to equalizer 74. In a second type of heat adjustment cell 118″, the corresponding coefficient 86 is processed to detect correlation between changes in the coefficient 86 and heat changes as expressed by heat signal 84. Moreover, in this second type of heat adjustment cell 118″ a feedback loop is closed and an offset 120 is generated which counters and reduces the correlation. This offset 120 is used to adjust the coefficient 86 and form a tap 77. Any number of first and/or second heat adjustment cells 118′ and 118″ may be used, with first heat adjustment cells 118′ being used in connection with coefficients 86 that are less sensitive to the effects of signal-generated component heating.

For each second heat adjustment cell 118″, the coefficient 86 is applied at an input to a high pass filter 120 and to a first positive input of a combiner 122. The output of high pass filter 120 provides a data stream which signals changes in the coefficient 86 with respect to a long term nominal value. The output of high pass filter 120 and heat signal 84 respectively drive integrate and dump sections 124 and 126. Integrate and dump sections 124 and 126 retard the rate of the data flowing through heat adjustment cell 118″. In the preferred embodiment, heat signal 84 and coefficient 86 may each provide updated samples at a rate that is two or more orders of magnitude faster than can be perceived in signal-generated component heating. Integrate and dump sections 124 and 126 slow this data to a rate compatible with signal-generated component heating for a power savings.

Integrate and dump section 126 generates an nominal heat signal [H′(n)], and integrate and dump section 124 generates a nominal coefficient signal [C′(n)]. After scaling by a heat coefficient [α(n)] (discussed below) in a multiplier 128, a predicted nominal coefficient [α(n)H′(n)] is then compared with the actual nominal coefficient signal [C′(n)] in a subtraction circuit 130. The predicted nominal coefficient [α(n)H′(n)] is based on heating and on previous values for the coefficient. Subtraction circuit 130 closes a feedback loop and produces an error signal [ε(n)] that corresponds to the difference between the nominal coefficient [C′(n)] and the predicted nominal coefficient based on heating.

The error signal [ε(n)] is then multiplied by the nominal heat signal [H′(n)] in a multiplier 132. The product output by multiplier 132 signals correlation between the error signal [ε(n)] and the nominal heat signal [H′(n)]. The output from multiplier 132 is scaled by a suitable loop constant “λ” in a multiplier 134, and the result integrated in an integrator formed from a combining circuit 136 and a delay element 138. An output of multiplier 134 couples to a first positive input of combining circuit 136, an output of combining element 136 couples to an input of delay element 138, and an output of delay element 138 couples to a second positive input of combining circuit 136. It is the output of this integrator at delay element 138 that provides a current heat coefficient [α(n)] and couples to an input of multiplier 128. The heat coefficient [α(n)] is an estimate of the sensitivity of the coefficient 86 to heat, as expressed by heat signal 84. Polarities are arranged, particularly at subtraction circuit 130, so that the heat coefficient [α(n)] increases or decreases as necessary to reduce the correlation instantaneously signaled at the output of multiplier 132 and accumulated through the operation of the integrator.

The current heat coefficient [α(n)], which remains valid for the integration period of integrate and dump sections 124 and 126, is used to scale the heat signal 84 samples in a multiplier 140, and each scaled current heat signal sample output from multiplier 140 forms an offset 142. An output from multiplier 140 couples to a second positive input of combining circuit 122. Offset 142 is then added to the current coefficient 86 to adjust coefficient 86 and form a current tap 77, which is provided to equalizer 74 (FIG. 2).

Thus, the embodiment of heat adjustment cell 118″ shown in FIG. 4 provides a feedback loop that predicts how signal-generated component heating urges a given coefficient 86 to move. In addition, heat adjustment cell 118″ generates an offset 142 that causes a corresponding tap 77 to veer in the direction that signal-generated component heating would otherwise urge the coefficient 86 to move. Thus, offsets 142 minimize fluctuations in coefficients 86 that are correlated with heat signal 84, making coefficients 86 even less responsive to signal-generated component heating that they would otherwise be. The loop constant “λ” controls the loop bandwidth for this feedback loop. In the preferred embodiment, the loop constant “λ” is adjusted so that this feedback loop exhibits a narrower bandwidth than is exhibited by the feedback loop closed in coefficient update section 82 (FIGS. 2-3). This narrow bandwidth is permitted because the feedback loop primarily tracks ambient temperature changes and component aging once temperature sensitivity has been resolved.

Referring back to FIG. 2, the tracking loops closed in heat adjustment section 80 and coefficient update section 82 may benefit from initiation operations prior to engaging in normal operations. For example, loop bandwidth constant 88 may be initially set to wider bandwidth so that heat adjustment section 80 can more quickly resolve heat sensitivities, then set to a narrower bandwidth for normal operation. In addition, the timing of the generation of coefficients 86 is desirably aligned with the timing of heat signal 84. This timing parameter can be aligned by finding that time delay for variable delay element 94 that maximizes the correlation between coefficient 86 deviations and deviations expressed by heat signal 84. The maximum correlation is desirably determined using the coefficient 86 corresponding to the center of equalizer 74. Moreover, sensitivity to the corner frequency of low pass filter 93 may be investigated by implementing a suitable search algorithm to further increase correlation between changes in coefficient 86 and heat signal 84 in response to different corner frequencies. After these and other initializing operations, the tracking loops closed in heat adjustment section 80 and coefficient update section 82 are then ready for normal operation.

A variety of alternate embodiments may be provided in connection with the implementation of equalizer 74. FIGS. 1 and 2 show an embodiment in which a single digital equalizer 74 is used to process transmit signal 22 so that equalized transmit signal 76 precisely matches transmit-corrupted receive signal 42 at combiner 68. In one alternate embodiment, the interfering portion of transmit-corrupted receive signal 42 may be at such a great level that equalization is advantageously implemented in two stages. In this embodiment, a first stage may be performed at radio frequencies in an analog-implemented adaptive equalizer (not shown) placed in receive signal path 54 prior to downconversion and digitization. In other embodiments, such a first stage may be implemented at an intermediate frequency or at baseband. The teaching of FIGS. 1 and 2 may work in conjunction with such a first stage, with equalizer 74 being a digitally implemented second stage.

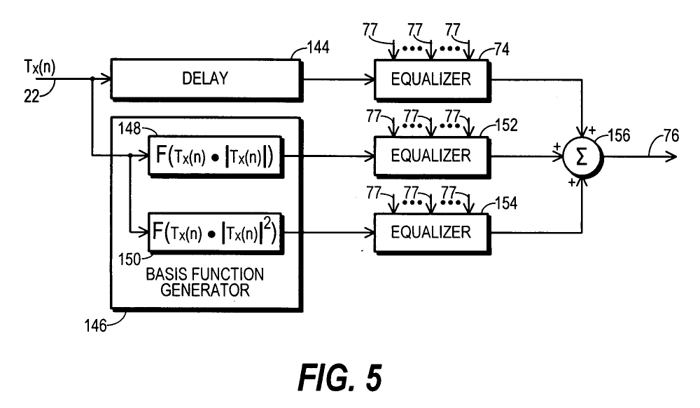

FIG. 5 shows another alternate embodiment of an equalizer portion of receiver 14. The embodiment of FIG. 5 may be used with or without the analog equalization discussed above. The embodiment of FIGS. 1 and 2 is capable of adjusting timing, phase, and amplitude of transmit signal 22 as needed to match the interfering portion of transmit-corrupted receive signal 42. But the embodiment of FIGS. 1 and 2 does not adjust the spectral character of transmit signal 22. On the other hand, spectral noise caused by intermodulation in receive signal path 54 can also be present in transmit-corrupted receive signal 42. Such intermodulation-caused spectral noise is likely to be spectrally related to transmit signal 22, and more likely to be present in significant quantities as the interfering portion of transmit-corrupted receive signal 42 increases.

In this embodiment, the digital, baseband version of transmit signal 22 from downconvert and digitize section 72 (FIG. 2) is routed to an input of a delay element 144 and to an input of a basis function generator 146. Basis function generator 146 generates one or more functions that are spectrally related to transmit signal 22. FIG. 5 depicts the generation of two of such basis functions. A second-order basis function is generated in a section 146 as a signal which is a function of transmit signal 22 times the magnitude of transmit signal 22. A third-order basis function is generated as a signal which is a function of transmit signal 22 times the square of the magnitude of transmit signal 22. Transmit signal 22, the second-order basis function from section 148, and the third-order basis function from section 150 are respectively routed to signal inputs of equalizers 74, 152, and 154. Signal outputs from equalizers 74, 152 and 154 are combined together at a combiner 156, and the combined signal output from combiner 156 serves as equalized transmit signal 76. Delay element 144, and sections 148 and 150 are desirably configured so that their respective output signals exhibit identical timing at combiner 156. Taps 77 provided to each of equalizers 74, 152, and 154 may be supplied from tap update section 78, discussed above in connection with FIGS. 2-4.

Accordingly, the FIG. 5 embodiment of the equalizer portion of receiver 14 also processes transmit signal 22 to generate and equalize spectrally related components of transmit signal 22. A more complete cancellation of the transmit signal corruption from transmit-corrupted receive signal 42 results.

In summary, at least one embodiment of transceiver 10 provides an improved transmit-canceling transceiver that is responsive to a heat signal and an improved method for operating a transmit-canceling transmitter. In accordance with at least one embodiment of transceiver 10, greater precision is achieved in canceling transmit signal corruption in a received signal. In accordance with at least one embodiment of transceiver 10, greater cancellation precision is maintained both for steady state conditions and for dynamic conditions where analog components experience signal-generated component heating. In accordance with at least one embodiment of transceiver 10, separate feedback loops are provided to achieve a highly precise long-term average match between a transmit signal and a transmit-corrupted receive signal and to track deviations from that long-term average due to signal-generated component heating.

Although the preferred embodiments of the invention have been illustrated and described in detail, it will be readily apparent to those skilled in the art that various modifications may be made therein without departing from the spirit of the invention or from the scope of the appended claims. For example, those skilled in the art may readily adapt sections and components discussed herein to process complex signals, as may be called for in any specific application. Moreover, those skilled in the art may readily combine the teaching presented herein with other transmit signal cancellation techniques to achieve as complete a cancellation as may be required by a given application. Such modifications and adaptations which are obvious to those skilled in the art are to be included within the scope of the present invention.

What is claimed is:

1. A transmit-canceling transceiver configured to simultaneously broadcast a transmit signal and detect a transmit-corrupted receive signal, said transceiver comprising:
an equalizer responsive to said transmit signal and configured to generate an equalized transmit signal;
a combiner responsive to said transmit-corrupted receive signal and to said equalized transmit signal, said combiner being configured to generate a transmit-canceled receive signal;
a heating estimator configured to generate a heat signal responsive to temperatures experienced by components which process said transmit signal; and
a tap update section responsive to said transmit signal, said transmit-canceled receive signal, and said heat signal, said tap update section being configured to adaptively generate taps provided to said equalizer.

2. A transceiver as claimed in claim 1 wherein said heat signal is generated in response to temperature measurements taken at one of said components which process said transmit signal.

3. A transceiver as claimed in claim 1 wherein:
said transmit signal propagates toward said equalizer along a signal path that includes a first set of analog components;
said transmit-corrupted receive signal propagates toward said combiner along a signal path that includes a second set of analog components; and
each of said first set of analog components and said second set of analog components processes said transmit signal.

4. A transceiver as claimed in claim 3 wherein:
said first set of analog components includes a first bandpass filter configured to pass a receive signal band and substantially block a transmit signal band;
said second set of analog components includes a second bandpass filter configured to pass said receive signal band and substantially block said transmit signal band; and
said transmit signal propagates toward said heating estimator along a signal path configured to pass said transmit signal band.

5. A transceiver as claimed in claim 1 wherein said equalizer, said combiner, said heating estimator, and said tap update section are implemented digitally.

6. A transceiver as claimed in claim 1 wherein said heat signal is generated in response to said transmit signal.

7. A transceiver as claimed in claim 1 additionally comprising a detector adapted to receive and demodulate said transmit-canceled receive signal.

8. A transceiver as claimed in claim 1 wherein said tap update section comprises:
a coefficient update section coupled to said combiner and configured to close a feedback loop which generates coefficients for said equalizer; and
a heat adjustment section coupled to said coefficient update section and to said equalizer.

9. A transceiver as claimed in claim 8 wherein said coefficient update section implements an LMS coefficient adaptation algorithm.

10. A transceiver as claimed in claim 8 wherein:
said coefficients generated by said coefficient update section are substantially unresponsive to said heat signal; and
said heat adjustment section forms said taps by adding at least one offset to at least one of said coefficients generated by said coefficient update section, said offset being formed in response to said heat signal.

11. A transceiver as claimed in claim 10 wherein said offset is responsive to correlation between changes in said at least one coefficient and changes in said heat signal.

12. A transceiver as claimed in claim 10 wherein said heat adjustment section closes a feedback loop which generates said offset.

13. A transceiver as claimed in claim 12 wherein a loop bandwidth of said feedback loop which generates said offset is narrower than a loop bandwidth of said feedback loop which generates said coefficients.

14. A transceiver as claimed in claim 8 wherein a loop bandwidth of said feedback loop which generates said coefficients for said equalizer is too narrow to track influences of signal-generated component heating in said components which process said transmit signal.

15. A method of reducing transmit signal corruption in a transmit-corrupted receive signal processed by a transceiver configured to simultaneously broadcast a transmit signal and detect said transmit-corrupted receive signal, said method comprising:
filtering said transmit signal to generate an equalized transmit signal, said filtering being performed in response to a set of taps;
combining said transmit-corrupted receive signal with said equalized transmit signal to generate a transmit-canceled receive signal;
estimating temperatures experienced by components which process said transmit signal to generate a heat signal; and
updating said set of taps in response to said transmit signal, said transmit-canceled receive signal, and said heat signal.

16. A method as claimed in claim 15 additionally comprising demodulating said transmit-canceled receive signal.

17. A method as claimed in claim 15 wherein said updating operation comprises:
generating coefficients for said equalizer in a feedback loop, said coefficients being substantially unresponsive to said heat signal; and
forming said set of taps by adjusting at least one of said coefficients in response to said heat signal.

18. A method as claimed in claim 17 wherein said forming operation comprises
adding at least one offset to at least one tap from said set of taps, wherein said offset is responsive to correlation between changes in said one tap and changes in said heat signal.

19. A method as claimed in claim 18 wherein said forming operation closes a feedback loop which generates said offset.

20. A method as claimed in claim 19 wherein a loop bandwidth of said feedback loop which generates said offset is narrower than a loop bandwidth of said feedback loop which generates said coefficients.

21. A method as claimed in claim 17 wherein a loop bandwidth of said feedback loop which generates said coefficients is too narrow to track influences of signal-generated component heating in said components which process said transmit signal.

22. A transmit-canceling transceiver configured to simultaneously broadcast a transmit signal and detect a transmit-corrupted receive signal, said transceiver comprising:
an equalizer responsive to said transmit signal after being processed through a signal path that includes a first set of analog components, said equalizer being configured to generate an equalized transmit signal;
a combiner responsive to said transmit-corrupted receive signal after being processed through a signal path that includes a second set of analog components, said combiner also being responsive to said equalized transmit signal and being configured to generate a transmit-canceled receive signal;
a detector adapted to receive and demodulate said transmit-canceled receive signal;
a heating estimator configured to generate a heat signal responsive to temperatures experienced by at least one component from said first and second sets of analog components;
a coefficient update section coupled to said combiner and configured to close a feedback loop which adaptively generates coefficients for said equalizer, said coefficients being substantially unresponsive to said heat signal; and
a heat adjustment section coupled to said coefficient update section and said equalizer, said heat adjustment section forming taps which are provided to said equalizer, said taps being formed by adding at least one offset to at least one of said coefficients generated by said coefficient update section, said offset being formed in response to said heat signal.

23. A transceiver as claimed in claim 22 wherein said heat adjustment section closes a feedback loop which generates said offset.

24. A transceiver as claimed in claim 23 wherein a loop bandwidth of said feedback loop which generates said offset is narrower than a loop bandwidth of said feedback loop which generates said coefficients.

25. A transceiver as claimed in claim 22 wherein a loop bandwidth of said feedback loop which generates said coefficients for said equalizer is too narrow to track influences of signal-generated component heating in said first and second sets of analog components.
